(19) United States
(12) Patent Application Publication
(10) Pub. No.: US 2024/0079176 A1
(43) Pub. Date: Mar. 7, 2024

(54) COIL DEVICE

(71) Applicant: TDK CORPORATION, Tokyo (JP)

(72) Inventors: Toshiyuki HORIKAWA, Tokyo (JP); Shinji HIGA, Tokyo (JP)

(73) Assignee: TDK CORPORATION, Tokyo (JP)

(21) Appl. No.: 18/457,064

(22) Filed: Aug. 28, 2023

(30) Foreign Application Priority Data
Sep. 1, 2022 (JP) 2022-139221
Sep. 1, 2022 (JP) 2022-139222

(51) Int. Cl. H01F 27/29; H01F 27/28; H01F 27/30

(52) U.S. Cl. CPC H01F 27/29; H01F 27/2828; H01F 27/306

(57) ABSTRACT

A coil device includes: a bobbin having a winding core portion with a hollow cylindrical shape; a core at least partially disposed inside the winding core portion; a wire having a coil portion wound around the winding core portion and a lead portion having a wire connection portion led out from the coil portion to extend substantially parallel to a winding axis O of the coil portion; and a terminal portion having a connection portion connected to the wire at the wire connection portion. A connection portion inner end, which is a position closest to the winding axis in an X-axis direction perpendicular to the winding axis O, of contact portions of the wire connection portion in the connection portion is disposed closer to the winding axis O in the X-axis direction than a first outer end portion located at a position farthest from the winding axis O in the X-axis direction in the bobbin.

### BACKGROUND OF THE INVENTION

### Field of the Invention

The present disclosure relates to a coil device.

### Description of the Related Art

A coil device is used for various applications in various electrical products. For example, a coil device disclosed in Patent Literature 1 (JP-A-2019-102496) can be used as a vehicle-mounted leakage transformer or the like. The coil device disclosed in Patent Literature 1 is characterized in that a terminal is insert-molded in a case and positioning accuracy of the terminal is high.

However, considering connection work between the insert-molded terminal and a wire forming the coil, it is necessary to dispose a connection portion between the terminal and the wire at a position away from the coil. In the coil device as shown in Patent Literature 1, there is a limit to miniaturization of the device.

### BRIEF SUMMARY OF THE INVENTION

The present disclosure has been made in view of such circumstances, and an object of the present disclosure is to provide a coil device that can be downsized.

A coil device wire includes:
a bobbin having a winding core portion with a hollow cylindrical shape;
a core at least partially disposed inside the winding core portion;
a wire having a coil portion wound around the winding core portion and a lead portion having a wire connection portion led out from the coil portion to extend substantially parallel to a winding axis of the coil portion; and
a terminal portion having a connection portion connected to the wire at the wire connection portion, in which
a connection portion inner end of a contact portion of the wire connection portion in the connection portion is located at a position closest to the winding axis in a first axis direction perpendicular to the winding axis, and the connection position inner end is disposed closer to the winding axis in the first axis direction than a first outer end portion located at a position farthest from the winding axis in the first axis direction in the bobbin.

With this configuration, the terminal portion can be disposed closer to the winding axis than the first outer end portion, and the coil device can be downsized.

The first axis direction is a bobbin longitudinal direction perpendicular to a bobbin lateral direction, in which
a length of the bobbin is shortest among directions perpendicular to the winding axis, and the first outer end portion may extend along the bobbin lateral direction.

With this configuration, a length of the coil device in the first axis direction can be shortened. Further, with such a configuration, it is possible to reduce a dead space when the coil device is mounted on a substrate or the like, and it is possible to downsize an electronic device on which the coil device is mounted.

The connection portion may include a terminal extending portion extending along the first outer end portion.

With this configuration, a space for connecting the terminal portion and the lead portion can be reduced.

The terminal portion may include a fixing portion fixed to the bobbin, and the fixing portion may protrude perpendicularly from the terminal extending portion and may be inserted into a fixing hole formed in the bobbin.

With this configuration, the terminal portion can be attached to the bobbin after the terminal portion and the lead portion are connected. Therefore, it is not necessary to perform connection work with the terminal portion in a state of being attached to the bobbin in advance by insert molding or the like, and a space for the connection work becomes unnecessary.

The fixing portion may include a retaining portion that prevents the fixing portion from falling off the fixing hole.

With this configuration, even when the terminal portion is attached to the bobbin by press-fitting, the terminal portion is less likely to fall off the bobbin.

The connection portion may include an engagement portion on which the lead portion is hooked.

With this configuration, it is easy to perform the connection work between the lead portion and the connection portion.

The terminal portion may include an external connection portion protruding more than a tip portion of the lead portion along the winding axis.

With such a configuration, by a method such as inserting the external connection portion into a substrate disposed above the coil device in a winding axis direction, time and effort for positioning can be omitted, and the coil device and the substrate can be stably fixed.

The wire may include a first wire having a first coil portion wound around the winding core portion and a first lead portion led out from the first coil portion, and a second wire having a second coil portion wound around the winding core portion and a lead portion led out from the second coil portion, and a winding partition flange formed on the bobbin may be disposed between the first coil portion and the second coil portion.

Such a coil device can be suitably used as a transformer. In addition, a leakage can be secured via the winding partition flange that separates the coil portions, and the coil device can be suitably used as a leakage transformer.

The lead portion may be further electrically connected to the connection portion by crimping or soldering.

Even in a case where the connection portion and the lead portion are connected in this manner, the terminal portion can be attached to the terminal block after the connection. Therefore, a space for the connection work becomes unnecessary, and a compact coil device can be easily manufactured.

Another coil device according to the present disclosure includes:
a bobbin having a winding core portion with a hollow cylindrical shape;
a core at least partially disposed inside the winding core portion;
a wire having a coil portion wound around the winding core portion and a lead portion having a wire connection portion led out from the coil portion and extending substantially parallel to a winding axis of the coil portion; and
a terminal portion having a connection portion connected to the wire at the wire connection portion, in which
a central portion of the lead portion
is disposed at an outer edge of a device body including the bobbin and the core and closer to the winding axis along a first axis than a first outer end portion located at a position farthest from the winding axis in a first axis direction perpendicular to the winding axis, and
is disposed at the outer edge of the device body and closer to the winding axis along a second axis than a second outer end portion located at a position farthest from the winding axis in a second axis direction perpendicular to the winding axis and the first axis.

With this configuration, the lead portion can be disposed at four corners as viewed along the winding axis of the device body, which are dead spaces of the coil device 1, and the coil device can be downsized.

The first outer end portion may be disposed on the bobbin, and the second outer end portion may be disposed on the core.

The bobbin may be formed with a terminal-side flange portion on which a terminal block to which the terminal portion is attached is disposed, and the terminal-side flange portion may be formed with an end guide groove through which the lead portion passes. With such a configuration, the lead portion can be easily disposed at a predetermined position inside the outer edge of the device body.
the central portion
may be disposed closer to the winding axis along the first axis than a first outer peripheral end located at a position farthest from the winding axis in the first axis direction in the coil portion, and
may be disposed closer to the winding axis along the second axis than a second outer peripheral end located at a position farthest from the winding axis in the second axis direction in the coil portion.

With this configuration, the lead portion can be more reliably accommodated at a predetermined position inside the outer edge of the device body.

The wire may include
a first wire having a first coil portion wound around the winding core portion and a first lead portion led out from the first coil portion, and
a second wire having a second coil portion wound around the winding core portion and a lead portion led out from the second coil portion, and
a winding partition flange formed on the bobbin may be disposed between the first coil portion and the second coil portion.

Such a coil device can be suitably used as a transformer. In addition, a leakage can be secured via the winding partition flange that separates the coil portions, and the coil device can be suitably used as a leakage transformer.

The winding partition flange may be formed with an intermediate guide groove through which the lead portion passes.

With this configuration, it is easy to determine a lead-out position of the lead portion.

The terminal portion may include an external connection portion protruding more than a tip portion of the lead portion along the winding axis.

With such a configuration, by a method such as inserting the external connection portion into a substrate disposed above the coil device in a winding axis direction, time and effort for positioning can be omitted, and the coil device and the substrate can be stably fixed.

The tip portion may be covered with a terminal cover.

With this configuration, the terminal portion can be prevented from falling off from the terminal block.

The lead portion may be further electrically connected to the connection portion by crimping or soldering.

Even in a case where the connection portion and the lead portion are connected in this manner, the terminal portion can be attached to the terminal block after the connection. Therefore, a space for the connection work becomes unnecessary, and a compact coil device can be easily manufactured.

### BRIEF DESCRIPTION OF THE DRAWINGS

FIG. 1 is a perspective view of a coil device according to an embodiment.

FIG. 2 is a partially exploded perspective view of the coil device shown in FIG. 1.

FIG. 3 is an enlarged perspective view of a wire in the coil device shown in FIG. 1.

FIGS. 4A and 4B are enlarged perspective views of a terminal portion in the coil device shown in FIG. 1.

FIG. 5 is an enlarged perspective view of a bobbin in the coil device shown in FIG. 1.

FIG. 6A is a perspective view showing a state before attachment of the terminal portion in the coil device shown in FIG. 1.

FIG. 6B is a perspective view of FIG. 6A viewed from another angle.

FIG. 7A is a perspective view showing a state in which the terminal portion shown in FIG. 6A is attached to the bobbin.

FIG. 7B is a perspective view of FIG. 7A viewed from another angle.

FIG. 8 is a plan view of FIG. 7A viewed from another angle.

FIG. 9 is a plan view of FIG. 7A as viewed from yet another angle.

FIG. 10 is a plan view of FIG. 7A as viewed from yet another angle.

FIG. 11 is a plan view of a combination of FIG. 10 and a core.

FIG. 12 is a cross-sectional view taken along a line XII-XII shown in FIG. 1.

FIGS. 13A and 13B are schematic views showing an example of a process of connecting a lead portion and the terminal portion shown in FIG. 6A.

### DETAILED DESCRIPTION OF THE INVENTION

Hereinafter, the present disclosure will be described based on embodiments shown in the drawings. Although the description will be made with reference to the drawings as necessary, the illustrated contents are merely schematically and exemplarily illustrated for the purpose of understanding the present disclosure, and the appearance, the dimensional ratio, and the like may be different from those of an actual object. Hereinafter, the present disclosure will be specifically described based on embodiments, but is not limited to these embodiments.

### First Embodiment

(Overall Configuration of Coil Device)

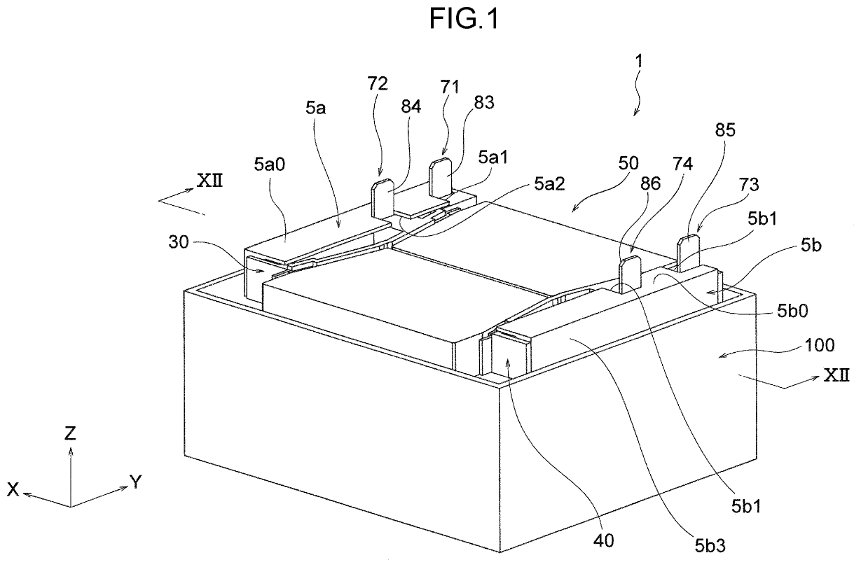

An overall configuration of a coil device according to an embodiment of the present disclosure will be described. The coil device according to the present embodiment shown in FIG. 1 is used as a transformer in, for example, an electric vehicle (EV), a plug-in hybrid vehicle (PHV), or an in-vehicle charger for a commuter (vehicle), and is used to constitute, for example, a part of an LLC circuit.

In the present embodiment, a size of a coil device 1 is not particularly limited, but for example, the coil device 1 may be designed to have a width of 30 mm to 80 mm in an X-axis direction, a width of 30 mm to 80 mm in a Y-axis direction, and a height of 30 mm to 80 mm in a Z-axis direction. In the drawings, the X axis, the Y axis, and the Z axis are perpendicular to each other.

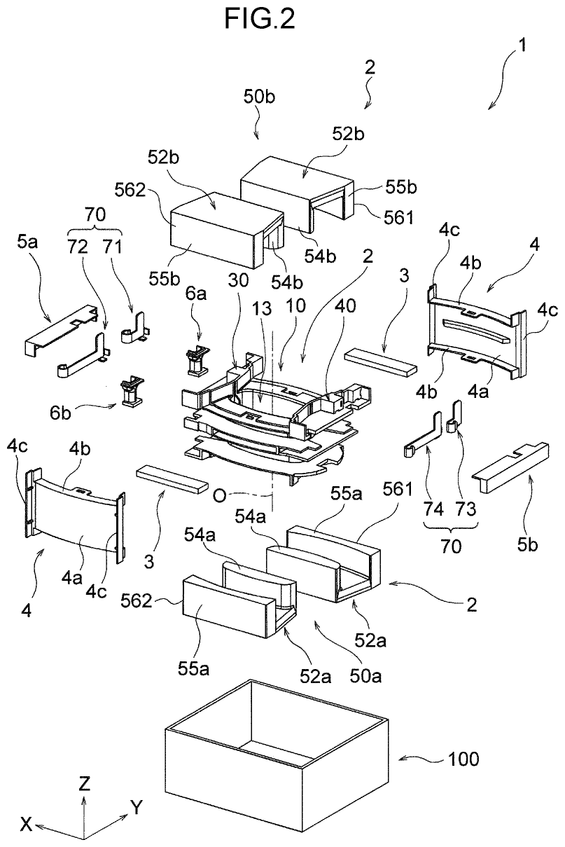

As shown in FIG. 2, the coil device 1 includes a bobbin 10, a core 50 attached to the bobbin 10, a terminal portion 70 attached to the bobbin 10, and a case 100 that accommodates the bobbin 10, the core 50 and the terminal portion 70 inside. Although not shown in FIG. 2, the coil device 1 includes a wire 60 wound around the bobbin 10. The bobbin 10 and the core 50 are included in a device body 2.

The Y-axis direction coincides with a bobbin lateral direction in which a length of the bobbin 10 is shortest, and the X-axis direction coincides with a bobbin longitudinal direction perpendicular to the bobbin latera direction. The Z-axis direction coincides with a direction in which a winding axis O extends.

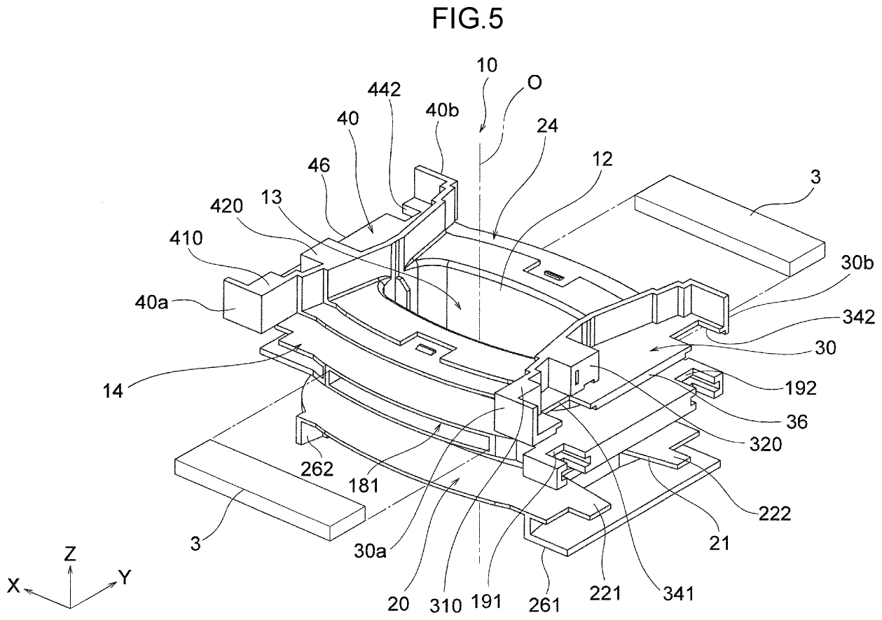

As shown in FIG. 5, the bobbin 10 has a winding core portion 12 with a hollow cylindrical shape. The winding core portion 12 extends along the Z-axis direction, and a core leg through hole 13 in which a middle leg portion, which is a part of the core 50, is disposed is provided inside the winding core portion 12. In the specification, in the X-axis direction and the Y-axis direction, a position close to the winding axis O along the Z axis may be referred to as “inner”, and a position far from the winding axis O along the Z axis may be referred to as “outer”.

The bobbin 10 is made of plastic such as PPS, PET, PBT, LCP, or nylon, but may be made of another insulating member. However, in the present embodiment, the bobbin 10 is preferably made of plastic having a high thermal conductivity of 1 W/m·K or more, for example, PPS, nylon, or the like.

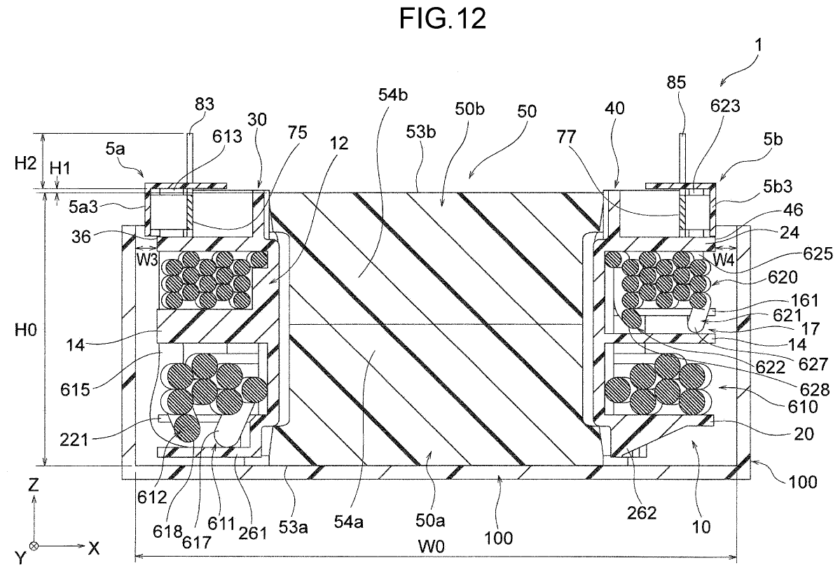

As shown in FIG. 12, the core 50 has a height H0. For example, H0 may be 30 mm to 80 mm, but is not limited thereto. As shown in FIG. 2, the core 50 includes a lower split core 50a disposed on a lower side in the Z-axis direction and an upper split core 50b disposed on an upper side in the Z-axis direction. In the specification, a direction in which the lower split core 50a is disposed along the Z axis may be referred to as “lower”, and a direction in which the upper split core 50b is disposed along the Z axis may be referred to as “upper”. Examples of a material of the core 50 include, but are not limited to, soft magnetic materials such as metal and ferrite.

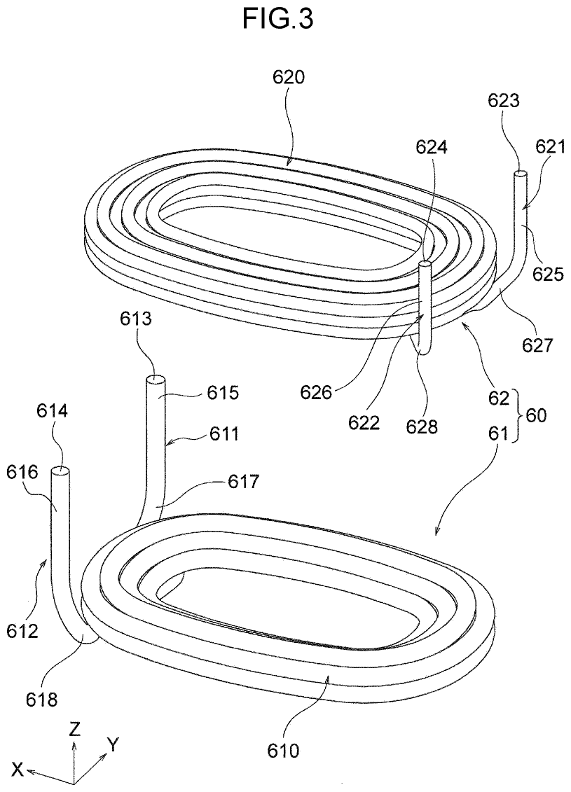

As shown in FIG. 3, the wire 60 includes a first wire 61 and a second wire 62. Each wire has a coil portion wound around a winding core portion of the bobbin and a lead portion led out from the coil portion. In the present embodiment, the first wire 61 constitutes a primary coil in the transformer, and the second wire 62 constitutes a secondary coil, but the present invention is not limited thereto, and the primary coil and the secondary coil may be interchanged to be used as a transformer. The first wire 61 and the second wire 62 may have the same or different outer diameters. In the present embodiment, the outer diameter of the first wire 61 is designed to be, for example, 1.0 mm to 4.0 mm, and the outer diameter of the second wire 62 is designed to be, for example, 3.0 mm to 4.0 mm, but the present invention is not limited thereto.

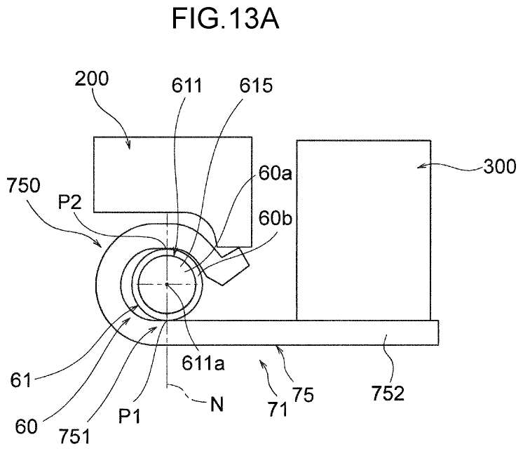

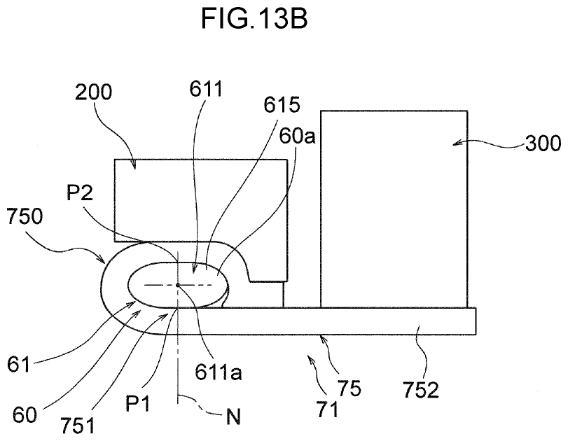

For example, a wire in which a core member 60a shown in FIG. 13A made of a good conductor such as copper (Cu) is covered with an insulating film 60b made of imide-modified polyurethane or the like, and an outermost surface is further covered with a thin resin film such as polyester may be used as the wire 60. The wire 60 is not particularly limited, but a Litz wire or the like is preferably used. In the present embodiment, a cross-sectional shape of the wire 60 is illustrated as a substantially circular shape for convenience in the drawings other than FIG. 13B, but as shown in FIG. 13B, the wire 60 has a shape in which the substantially circular cross-sectional shape is crushed in a process of assembling the coil device. The cross-sectional shape of the wire 60 is not limited thereto, and may be a substantially circular shape as shown in FIG. 13A.

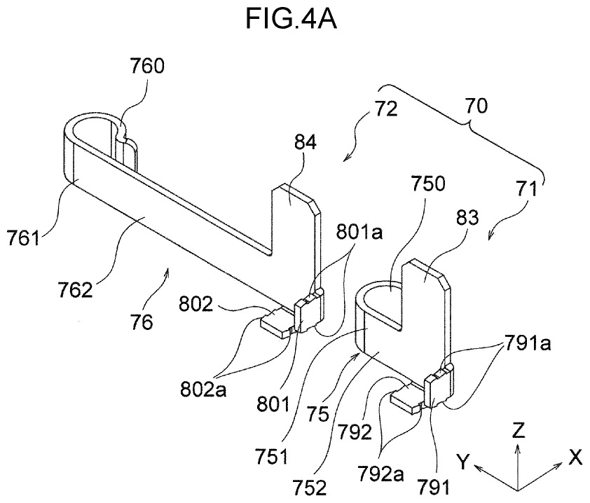

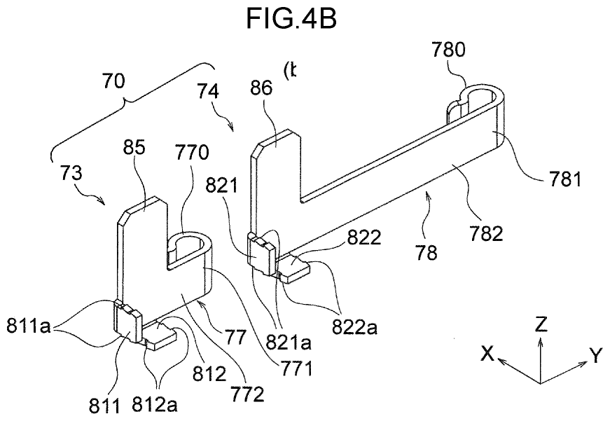

As shown in FIGS. 4A and 4B, the terminal portion 70 includes a primary first terminal portion 71, a primary second terminal portion 72, a secondary first terminal portion 73, and a secondary second terminal portion 74. The terminal portion 70 may be formed into a shape shown in FIGS. 4A and 4B by bending a conductive strip-shaped plate material containing, as main components, copper alloys such as phosphor bronze and brass, phosphorus, copper, tin, iron, zinc, and the like. Further, in the terminal portion 70, a known plating layer of nickel, tin, or the like may be formed on a surface of the connection portion with the wire.

As shown in FIG. 2, the case 100 has a substantially rectangular outer shape, and an upper portion in the Z-axis direction is open. As shown in FIG. 1, in the present embodiment, a height of the case 100 is lower than positions of upper portions of terminal blocks 30 and 40 and the core 50, but may be higher than these positions. The case 100 is preferably made of a metal such as aluminum copper or iron having an excellent heat dissipation property, but may be made of a resin such as PPS, PET, or PBT.

As shown in FIG. 1 and the like, an inside of the case 100, more specifically, a gap between the bobbin 10 and the core 50 accommodated in the case 100 and an inner surface of the case 100 is filled with potting resin for heat dissipation. The potting resin for heat dissipation is not particularly limited, but for example, a resin having a thermal conductivity of preferably 0.5 to 5 W/m·K, more preferably 1 to 3 W/m·K is preferably used. Examples of the potting resin having an excellent heat dissipation property include a silicone-based resin, a urethane-based resin, and an epoxy-based resin. Among them, the silicone resin and the urethane resin are preferably used. In order to enhance the heat dissipation property, the potting resin may contain a filler having a high thermal conductivity.

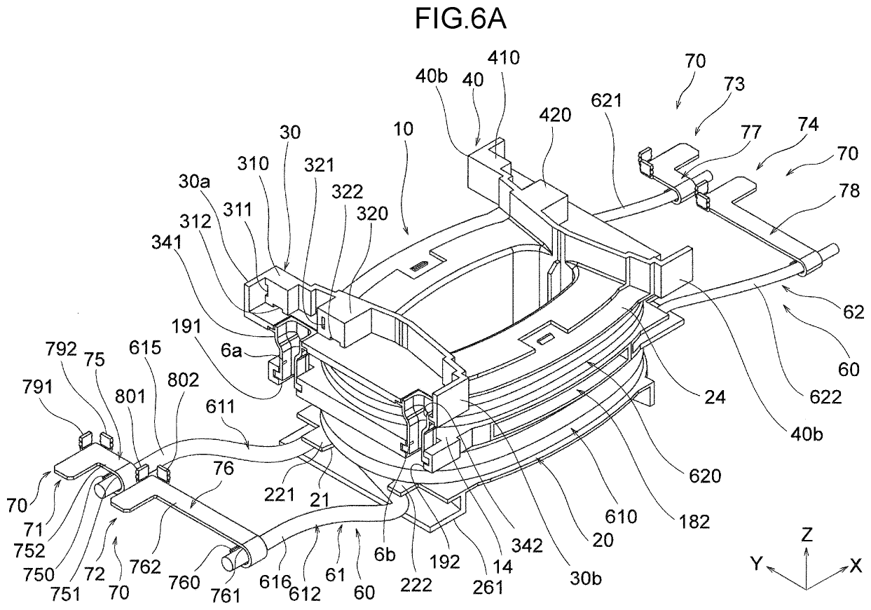

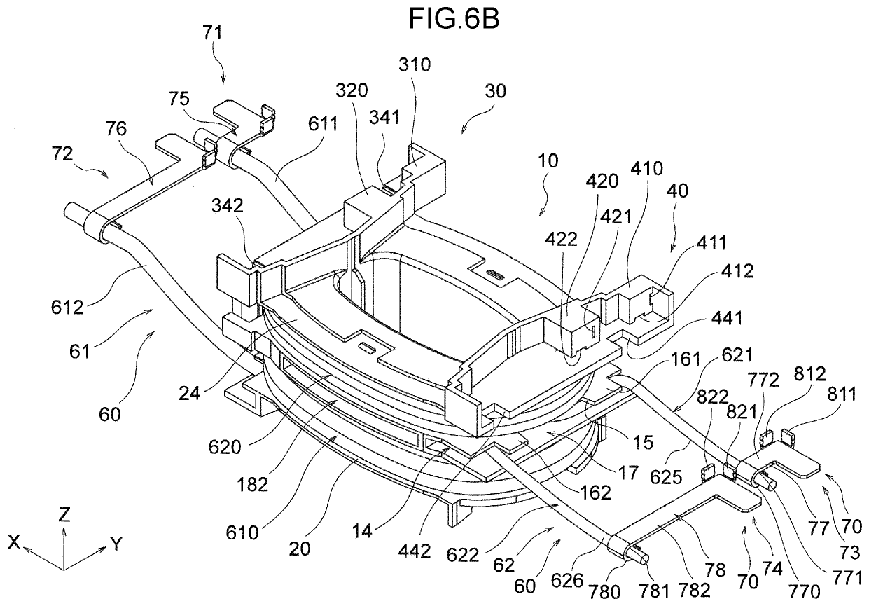

As shown in FIG. 5, the bobbin 10 has the winding core portion 12 with a hollow cylindrical shape having the core leg through hole 13 penetrating in the Z-axis direction. As shown in FIG. 6A, the first wire 61 and the second wire 62 are wound around the winding core portion 12.

As shown in FIG. 5, the bobbin 10 includes the terminal-side flange portion 24 disposed on the upper side of the winding core portion 12 in the Z-axis direction. The terminal blocks 30 and 40 are formed above the terminal-side flange portion 24 in the Z-axis direction. The terminal block 30 is disposed at one end of the terminal-side flange portion 24 in the X-axis direction. In the present embodiment, the terminal block 30 is provided with a first outer end portion 36 located at a position farthest from the winding axis O in the X-axis direction on the bobbin 10. The terminal block 40 is disposed at the other end of the terminal-side flange portion 24 in the X-axis direction. In the present embodiment, the terminal block 40 is provided with a first outer end portion 46 located at a position farthest from the winding axis O in the X-axis direction on the bobbin 10. The first outer end portions 36 and 46 extend along the Y-axis direction which is the bobbin lateral direction.

As shown in FIG. 5, the terminal block 30 is formed with a first terminal installation portion 310 to which the primary first terminal portion 71 shown in FIG. 4A is attached. As shown in FIG. 6A, fixing holes 311 and 312 recessed in the X-axis direction are formed in the first terminal installation portion 310.

As shown in FIG. 5, the terminal block 30 is formed with a second terminal installation portion 320 to which the primary second terminal portion 72 shown in FIG. 4A is attached. As shown in FIG. 6A, fixing holes 321 and 322 recessed in the X-axis direction are formed in the second terminal installation portion 320.

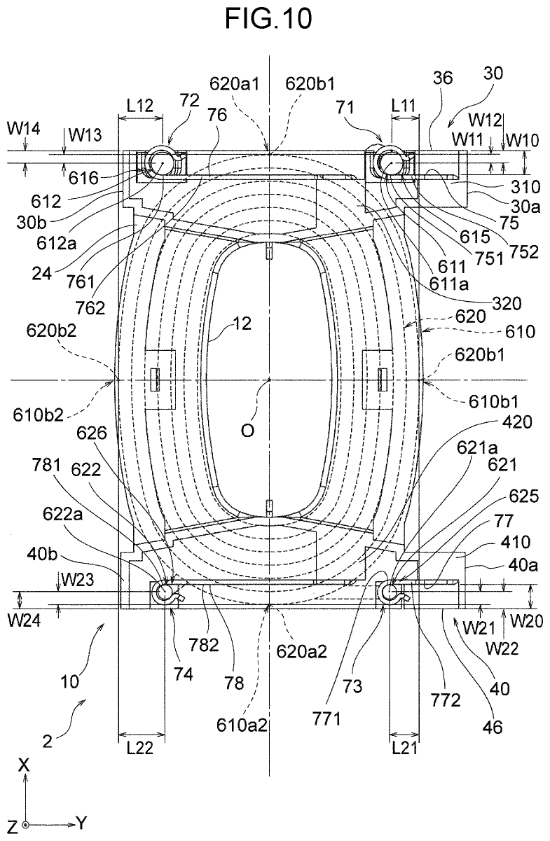

As shown in FIG. 10, in the terminal block 30, the first terminal installation portion 310 and the second terminal installation portion 320 are formed side by side along the Y-axis direction. Both the first terminal installation portion 310 and the second terminal installation portion 320 are disposed on one side in the Y-axis direction with respect to the winding axis O. The first terminal installation portion 310 is disposed on a first end side 30a of the terminal block 30 in the Y-axis direction, and the second terminal installation portion 320 is disposed closer to the winding axis O along the Y-axis direction than the first terminal installation portion 310.

As shown in FIG. 5, end guide grooves 341 and 342 are formed side by side along the Y-axis direction in the terminal-side flange portion 24 on which the terminal block 30 is formed. The end guide groove 341 is disposed between the first terminal installation portion 310 and the second terminal installation portion 320 along the Y-axis direction. The end guide groove 342 is disposed on a second end side 30b of the terminal block 30 in the Y-axis direction.

As shown in FIG. 5, the terminal block 40 is formed with a first terminal installation portion 410 to which the secondary first terminal portion 73 shown in FIG. 4B is attached. As shown in FIG. 6B, fixing holes 411 and 412 recessed in the X-axis direction are formed in the first terminal installation portion 410.

As shown in FIG. 5, the terminal block 40 is formed with a second terminal installation portion 420 to which the secondary second terminal portion 74 shown in FIG. 4B is attached. As shown in FIG. 6B, fixing holes 421 and 422 recessed in the X-axis direction are formed in the second terminal installation portion 420.

As shown in FIG. 10, in the terminal block 40, the first terminal installation portion 410 and the second terminal installation portion 420 are formed side by side along the Y-axis direction. Both the first terminal installation portion 410 and the second terminal installation portion 420 are disposed on one side in the Y-axis direction with respect to the winding axis O. The first terminal installation portion 410 is disposed on a first end side 40a of the terminal block 40 in the Y-axis direction, and the second terminal installation portion 420 is disposed closer to the winding axis O along the Y-axis direction than the first terminal installation portion 410.

As shown in FIG. 5, end guide grooves 441 and 442 are formed side by side along the Y-axis direction in the terminal-side flange portion 24 on which the terminal block 40 is formed. The end guide groove 441 is disposed between the first terminal installation portion 410 and the second terminal installation portion 420 along the Y-axis direction. The end guide groove 442 is disposed on a second end side 40b of the terminal block 40 in the Y-axis direction.

As shown in FIG. 5, the bobbin 10 includes a winding partition flange 14 disposed below the terminal-side flange portion 24 in the Z-axis direction in the winding core portion 12. In the winding partition flange 14, intermediate guide grooves 191 and 192 are formed side by side along the Y-axis direction at positions below the terminal block 30 in the Z-axis direction. The intermediate guide groove 191 is disposed substantially directly below the end guide groove 341 in the Z-axis direction. The intermediate guide groove 192 is disposed substantially directly below the end guide groove 342 in the Z-axis direction.

As shown in FIG. 6A, an insulating cover 6a is fitted into the end guide groove 341 and the intermediate guide groove 191 so as to bridge the terminal-side flange portion 24 and the winding partition flange 14. An insulating cover 6b is fitted into the end guide groove 342 and the intermediate guide groove 192 so as to bridge the terminal-side flange portion 24 and the winding partition flange 14.

As shown in FIG. 6B, a lead-out groove 17 is formed in the winding partition flange 14 at a position below the terminal block 40 in the Z-axis direction. The winding partition flange 14 is formed with a lead-out notch 15 for leading out second lead portions 621 and 622 from a second coil portion 620. The winding partition flange 14 is formed with guide protrusions 161 and 162 on both sides of the lead-out notch 15 in the Y-axis direction. An outside of the guide protrusion 161 in the Y-axis direction is disposed below the end guide groove 441 in the Z-axis direction. An outside of the guide protrusion 162 in the Y-axis direction is disposed below the end guide groove 442 in the Z-axis direction.

As shown in FIG. 5, in the present embodiment, a lateral groove 181 is formed at one end of the winding partition flange 14 in the Y-axis direction, and as shown in FIG. 6A, a lateral groove 182 is formed at the other end of the winding partition flange 14 in the Y-axis direction. As shown in FIG. 5, in the present embodiment, a leakage core 3 is disposed in the lateral grooves 181 and 182. In the present embodiment, the leakage can be adjusted by providing the lateral grooves 181 and 182 and the leakage core 3, but the present invention is not limited to such a configuration. For example, the lateral grooves 181 and 182 and the leakage core 3 may not be provided if necessary to ensure the leakage.

As shown in FIG. 5, the bobbin 10 includes a leg-side flange portion 20 disposed below the winding partition flange 14 in the Z-axis direction in the winding core portion 12. Bobbin leg portions 261 and 262 are formed on the leg-side flange portion 20. The bobbin leg portion 261 is disposed below the terminal block 30 in the Z-axis direction. The bobbin leg portion 262 is disposed below the terminal block 40 in the Z-axis direction.

As shown in FIG. 5, the leg-side flange portion 20 is formed with a lead-out notch 21 for leading out first lead portions 611 and 612 from a first coil portion 610 at a position below the terminal block 30 in the Z-axis direction. The leg-side flange portion 20 is formed with guide protrusions 221 and 222 on both sides of the lead-out notch 21 in the Y-axis direction. An outside of the guide protrusion 221 in the Y-axis direction is disposed below the end guide groove 341 and the intermediate guide groove 191 in the Z-axis direction. An outside of the guide protrusion 222 in the Y-axis direction is disposed below the end guide groove 342 and the intermediate guide groove 192 in the Z-axis direction.

As shown in FIG. 12, the first coil portion 610 is wound around the winding core portion 12 between the leg-side flange portion 20 and the winding partition flange 14. In the present embodiment, the number of turns of the first coil portion 610 is plural, but may be singular. The number of turns of the first coil portion 610 can be appropriately determined according to properties required for the coil device 1, and is not particularly limited.

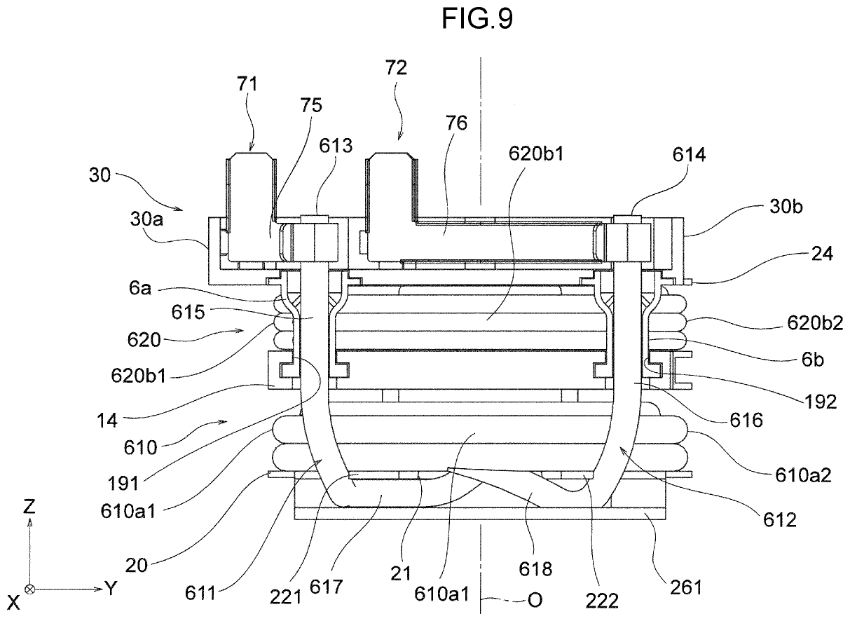

As shown in FIG. 9, the first lead portion 611 is led out from the first coil portion 610. The first lead portion 611 includes a base end portion 617 and a wire connection portion 615. As shown in FIG. 12, the base end portion 617 is connected to a lower side of the first coil portion 610 in the Z-axis direction, hooked to the outside of the guide protrusion 221 in the Y-axis direction, and connected to the wire connection portion 615.

As shown in FIG. 9, the wire connection portion 615 is led out from the first coil portion 610 and extends substantially parallel to the winding axis O. The wire connection portion 615 passes through a groove of the insulating cover 6a and is insulated from the second coil portion 620. The wire connection portion 615 is connected to the primary first terminal portion 71.

As shown in FIG. 9, the first lead portion 612 is led out from the first coil portion 610. The first lead portion 612 includes a base end portion 618 and a wire connection portion 616. As shown in FIG. 12, the base end portion 618 is connected to a lower side of the first coil portion 610 in the Z-axis direction, hooked to the outside of the guide protrusion 222 shown in FIG. 9 in the Y-axis direction, and connected to the wire connection portion 616.

As shown in FIG. 9, the wire connection portion 616 is led out from the first coil portion 610 and extends substantially parallel to the winding axis O. The wire connection portion 616 passes through a groove of the insulating cover 6b and is insulated from the second coil portion 620. The wire connection portion 616 is connected to the primary second terminal portion 72.

As shown in FIG. 12, the second coil portion 620 is wound around the winding core portion 12 between the terminal-side flange portion 24 and the winding partition flange 14. In the present embodiment, the number of turns of the second coil portion 620 is plural, but may be singular. The number of turns of the second coil portion 620 can be appropriately determined according to properties required for the coil device 1, and is not particularly limited.

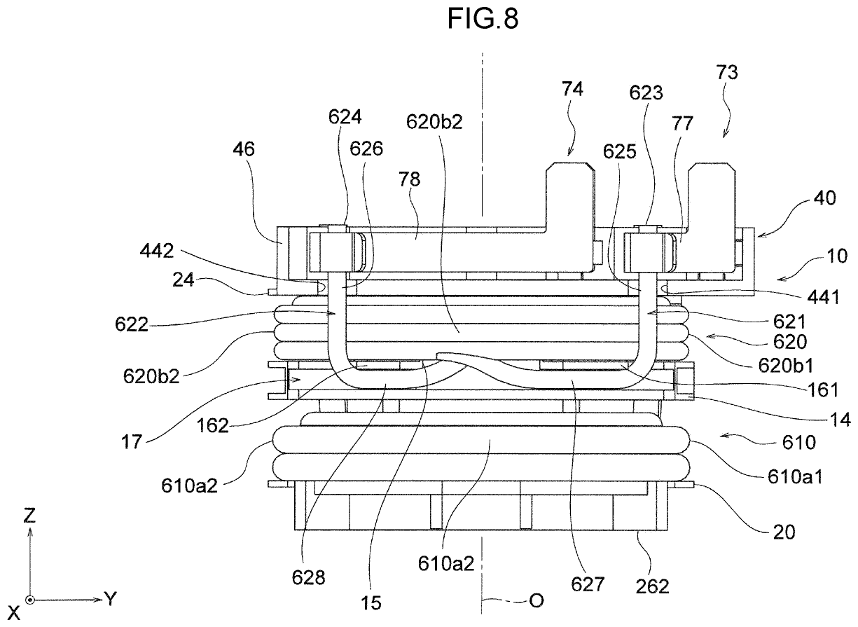

As shown in FIG. 8, the second lead portion 621 is led out from the second coil portion 620. The second lead portion 621 includes a base end portion 627 and a wire connection portion 625. As shown in FIG. 12, the base end portion 627 is connected to a lower side of the second coil portion 620 in the Z-axis direction, hooked to the outside of the guide protrusion 161 in the Y-axis direction, and connected to the wire connection portion 625.

As shown in FIG. 8, the wire connection portion 625 is led out from the second coil portion 620 and extends substantially parallel to the winding axis O. The wire connection portion 625 passes through the end guide groove 341 and is connected to the secondary first terminal portion 73.

As shown in FIG. 8, the second lead portion 622 is led out from the second coil portion 620. The second lead portion 622 includes a base end portion 628 and a wire connection portion 626. As shown in FIG. 12, the base end portion 628 is connected to a lower side of the second coil portion 620 in the Z-axis direction, hooked to the outside of the guide protrusion 162 shown in FIG. 8 in the Y-axis direction, and connected to the wire connection portion 626.

As shown in FIG. 8, the wire connection portion 626 is led out from the second coil portion 620 and extends substantially parallel to the winding axis O. The wire connection portion 626 passes through the end guide groove 342 and is connected to the secondary second terminal portion 74.

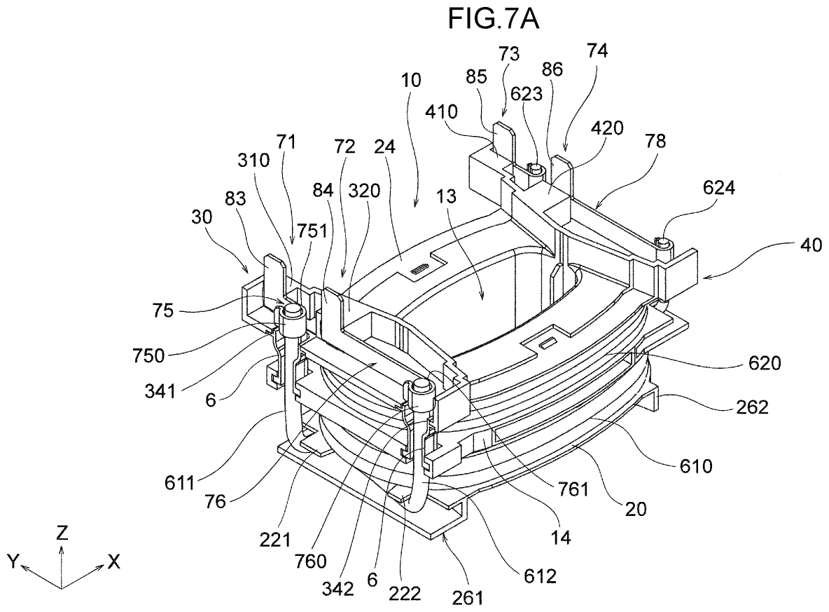

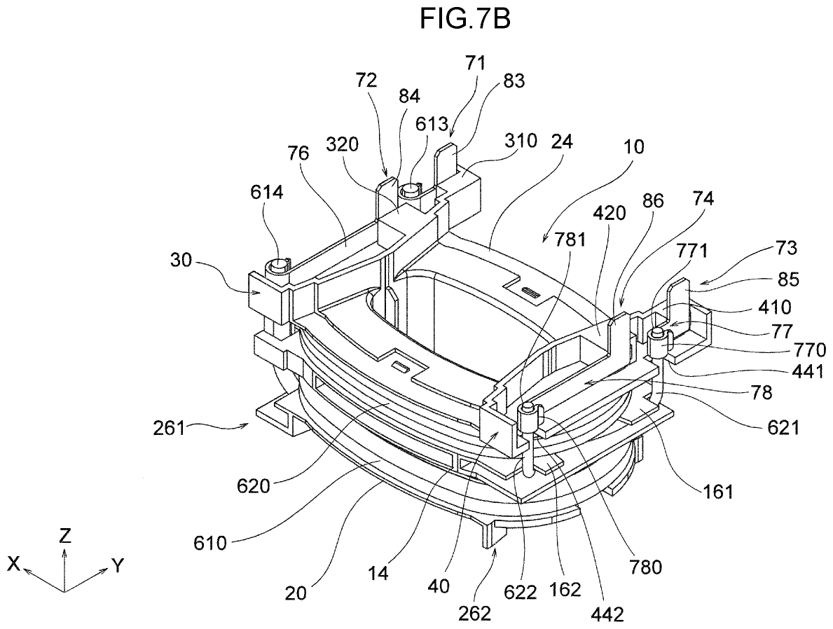

As shown in FIG. 7A, the primary first terminal portion 71 is attached to the first terminal installation portion 310. As shown in FIG. 4A, the primary first terminal portion 71 includes an external connection portion 83, a connection portion 75 connected to the wire at the wire connection portion, and fixing portions 791 and 792 fixed to the bobbin. The external connection portion 83 is connected to the connection portion 75 and protrudes upward in the Z-axis direction from a position corresponding to the first terminal installation portion 310 shown in FIG. 7A.

As shown in FIG. 4A, the connection portion 75 includes a terminal extending portion 752 extending in the Y-axis direction from the external connection portion 83 to a connection portion inner end 751, and an engagement portion 750. As shown in FIG. 10, the connection portion inner end 751 is located at a position closest to the winding axis O in the X-axis direction among contact portions of the wire connection portion 615 in the connection portion 75. As shown in FIG. 7A, the connection portion inner end 751 is disposed substantially directly above the end guide groove 341 in the Z-axis direction. As shown in FIG. 6A, the connection portion 75 sandwiches the wire connection portion 615 of the first lead portion 611 between the terminal extending portion 752 and the engagement portion 750.

As shown in FIG. 4A, the fixing portions 791 and 792 protrude perpendicularly from the terminal extending portion 752. The fixing portion 791 is disposed at a position corresponding to the fixing hole 311 shown in FIG. 6A. The fixing portion 792 is disposed at a position corresponding to the fixing hole 312 shown in FIG. 6A. The fixing portion 791 includes a retaining portion 791a that prevents the fixing portion 791 from falling off the fixing hole 311 shown in FIG. 6A. The fixing portion 792 includes a retaining portion 792a that prevents the fixing portion 792 from falling off the fixing hole 312 shown in FIG. 6A.

As shown in FIG. 7A, the primary second terminal portion 72 is attached to the second terminal installation portion 320. As shown in FIG. 4A, the primary second terminal portion 72 includes an external connection portion 84, a connection portion 76 connected to the wire at the wire connection portion, and fixing portions 801 and 802 fixed to the bobbin. The external connection portion 84 is connected to the connection portion 76 and protrudes upward in the Z-axis direction from a position corresponding to the second terminal installation portion 320 shown in FIG. 7A.

As shown in FIG. 4A, the connection portion 76 includes a terminal extending portion 762 extending in the Y-axis direction from the external connection portion 84 to a connection portion inner end 761, and an engagement portion 760. As shown in FIG. 10, the connection portion inner end 761 is located at a position closest to the winding axis O in the X-axis direction among contact portions of the wire connection portion 616 in the connection portion 76. The terminal extending portion 762 of the primary second terminal portion 72 is longer than the terminal extending portion 752 of the primary first terminal portion 71. As shown in FIG. 7A, the connection portion inner end 761 is disposed substantially directly above the end guide groove 342 in the Z-axis direction. As shown in FIG. 6A, the connection portion 76 sandwiches the wire connection portion 616 of the first lead portion 612 between the terminal extending portion 762 and the engagement portion 760.

As shown in FIG. 4A, the fixing portions 801 and 802 protrude perpendicularly from the terminal extending portion 762. The fixing portion 801 is disposed at a position corresponding to the fixing hole 321 shown in FIG. 6A. The fixing portion 802 is disposed at a position corresponding to the fixing hole 322 shown in FIG. 6A. The fixing portion 801 includes a retaining portion 801a that prevents the fixing portion 801 from falling off the fixing hole 321 shown in FIG. 6A. The fixing portion 802 includes a retaining portion 802a that prevents the fixing portion 802 from falling off the fixing hole 322 shown in FIG. 6A.

As shown in FIG. 7B, the secondary first terminal portion 73 is attached to the first terminal installation portion 410. As shown in FIG. 4B, the secondary first terminal portion 73 includes an external connection portion 85, a connection portion 77 connected to the wire at the wire connection portion, and fixing portions 811 and 812 fixed to the bobbin. The external connection portion 85 is connected to the connection portion 77 and protrudes upward in the Z-axis direction from a position corresponding to the first terminal installation portion 410 shown in FIG. 7B.

As shown in FIG. 4B, the connection portion 77 includes a terminal extending portion 772 extending in the Y-axis direction from the external connection portion 85 to a connection portion inner end 771, and an engagement portion 770. As shown in FIG. 10, the connection portion inner end 771 is located at a position closest to the winding axis O in the X-axis direction among contact portions of the wire connection portion 625 in the connection portion 77. As shown in FIG. 7B, the connection portion inner end 771 is disposed substantially directly above the end guide groove 441 in the Z-axis direction. As shown in FIG. 6B, the connection portion 77 sandwiches the wire connection portion 625 of the second lead portion 621 between the terminal extending portion 772 and the engagement portion 770.

As shown in FIG. 4B, the fixing portions 811 and 812 protrude perpendicularly from the terminal extending portion 772. The fixing portion 811 is disposed at a position corresponding to the fixing hole 411 shown in FIG. 6B. The fixing portion 812 is disposed at a position corresponding to the fixing hole 412 shown in FIG. 6B. The fixing portion 811 includes a retaining portion 811a that prevents the fixing portion 811 from falling off the fixing hole 411 shown in FIG. 6B. The fixing portion 812 includes a retaining portion 812a that prevents the fixing portion 812 from falling off the fixing hole 412 shown in FIG. 6B.

As shown in FIG. 7B, the secondary second terminal portion 74 is attached to the second terminal installation portion 420. As shown in FIG. 4B, the secondary second terminal portion 74 includes an external connection portion 86, a connection portion 78 connected to the wire at the wire connection portion, and fixing portions 821 and 822 fixed to the bobbin. The external connection portion 86 is connected to the connection portion 78 and protrudes upward in the Z-axis direction from a position corresponding to the second terminal installation portion 420 shown in FIG. 7B.

As shown in FIG. 4B, the connection portion 78 includes a terminal extending portion 782 extending in the Y-axis direction from the external connection portion 86 to a connection portion inner end 781, and an engagement portion 780. As shown in FIG. 10, the connection portion inner end 781 is located at a position closest to the winding axis O in the X-axis direction among contact portions of the wire connection portion 626 in the connection portion 78. The terminal extending portion 782 of the secondary second terminal portion 74 is longer than the terminal extending portion 772 of the secondary first terminal portion 73. As shown in FIG. 7B, the connection portion inner end 781 is disposed substantially directly above the end guide groove 442 in the Z-axis direction. As shown in FIG. 6B, the connection portion 78 sandwiches the wire connection portion 626 of the second lead portion 622 between the terminal extending portion 782 and the engagement portion 780.

As shown in FIG. 4B, the fixing portions 821 and 822 protrude perpendicularly from the terminal extending portion 782. The fixing portion 821 is disposed at a position corresponding to the fixing hole 421 shown in FIG. 6B. The fixing portion 822 is disposed at a position corresponding to the fixing hole 422 shown in FIG. 6B. The fixing portion 821 includes a retaining portion 821a that prevents the fixing portion 821 from falling off the fixing hole 421 shown in FIG. 6B. The fixing portion 822 includes a retaining portion 822a that prevents the fixing portion 822 from falling off the fixing hole 422 shown in FIG. 6B.

As shown in FIG. 1, a terminal cover 5a is attached to the terminal block 30. A terminal protection piece 5a0 of the terminal cover 5a covers an upper portion of the terminal block 30 in the Z-axis direction, and a side protection piece 5a3 of the terminal cover 5a covers an outside of the terminal block 30 in the X-axis direction. The external connection portion 83 protrudes from an external connection notch 5a1 of the terminal protection piece 5a0, and the external connection portion 84 protrudes from an external connection notch 5a2 of the terminal protection piece 5a0.

As shown in FIG. 1, a terminal cover 5b is attached to the terminal block 40. A terminal protection piece 5b0 of the terminal cover 5b covers an upper portion of the terminal block 40 in the Z-axis direction, and a side protection piece 5b3 of the terminal cover 5b covers an outside of the terminal block 40 in the X-axis direction. The external connection portion 85 protrudes from an external connection notch 5b1 of the terminal protection piece 5b0, and the external connection portion 86 protrudes from an external connection notch 5b2 of the terminal protection piece 5b0.

The terminal blocks 30 and 40 and the terminal covers 5a and 5b may be attached with an adhesive or the like, or may be attached by providing a structure that allows the terminal blocks and the terminal covers to fit together.

As shown in FIG. 2, in the present embodiment, the lower split core 50a and the upper split core 50b have the same shape, have an E-shaped cross section in a ZY cross section, and form an E-shaped core. The lower split core 50a and the upper split core 50b are further cut parallel to an XZ plane. The lower split core 50a and the upper split core 50b may not be cut parallel to the XZ plane. The shapes of the lower split core 50a and the upper split core 50b are not limited to the E-shaped core, and cores of other shapes may be used.

As shown in FIG. 2, the lower split core 50a disposed on the lower side in the Z-axis direction includes a base portion 52a extending in the Y-axis direction, a pair of side leg portions 55a protruding in the Z-axis direction from both ends of the base portion 52a in the Y-axis direction, and a middle leg portion 54a protruding in the Z-axis direction from the center in the Y-axis direction between the side leg portions 55a. In the present embodiment, the lower split core 50a is cut parallel to the XZ plane in the middle of the middle leg portion 54a in the Y-axis direction.

As shown in FIG. 2, the upper split core 50b disposed on the upper side in the Z-axis direction includes a base portion 52b extending in the Y-axis direction, a pair of side leg portions 55b protruding in the Z-axis direction from both ends of the base portion 52b in the Y-axis direction, and a middle leg portion 54b protruding in the Z-axis direction from the center in the Y-axis direction between the side leg portions 55b. In the present embodiment, the upper split core 50b is cut parallel to the XZ plane in the middle of the middle leg portion 54b in the Y-axis direction.

As shown in FIG. 2, the middle leg portion 54a is inserted into a core leg through hole 13 of the bobbin 10 from the lower side in the Z-axis direction. Similarly, the middle leg portion 54b is inserted into the core leg through hole 13 of the bobbin 10 from the upper side in the Z-axis direction. The middle leg portions 54a and 54b are configured such that distal ends thereof face each other inside the core leg through hole 13.

In the example shown in FIG. 12, the distal end of the middle leg portion 54b is in contact with the distal end of the middle leg portion 54a inside the core leg through hole 13, but a predetermined gap (not shown) may be formed between the distal end of the middle leg portion 54a and the distal end of the middle leg portion 54b. Accordingly, by forming the gap, leakage characteristics can be adjusted according to a width of the gap.

As shown in FIG. 2, the middle leg portion 54a and the middle leg portion 54b have a substantially elliptic cylinder shape so as to match a shape of an inner peripheral surface of the core leg through hole 13, but the shapes thereof are not particularly limited, and may be changed in accordance with a shape of the core leg through hole 13. The side leg portions 55a and 55b have an inner concave curved surface shape that matches an outer peripheral surface shape of the leg-side flange portion 20 and the terminal-side flange portion 24, and outer surfaces thereof in the Y-axis direction have flat surfaces parallel to the XZ plane. In the present embodiment, second outer end portions 561 and 562 located at a position farthest from the winding axis O in the Y-axis direction, which is a second axis direction, are disposed on the outer surfaces of the side leg portions 55a and 55b in the Y-axis direction.

As shown in FIG. 2, side covers 4 are disposed between the inner peripheral surfaces of the side leg portions 55a and 55b and outer peripheries of the leg-side flange portion 20 and the terminal-side flange portion 24. Each of the side covers 4 includes a cover body 4a that covers the outer peripheries of the leg-side flange portion 20 and the terminal-side flange portion 24 located between the terminal blocks 30 and 40 of the bobbin 10. At both ends of the cover body 4a of the side cover 4 in the Z-axis direction, engagement pieces 4b bent in a substantially perpendicular direction toward the bobbin 10 from the cover body 4a that covers the outer peripheries of the leg-side flange portion 20 and the terminal-side flange portion 24 are integrally molded. The pair of engagement pieces 4b formed on both sides of the cover body 4a in the Z-axis direction are attached so as to sandwich the bobbin 10 in contact with a lower surface of the leg-side flange portion 20 in the Z-axis direction and an upper surface of the terminal-side flange portion 24, respectively.

Side leg guide pieces 4c extending in the Z-axis direction are integrally formed on outer surfaces of both ends of the cover body 4a in the X-axis direction. Inner surfaces of the side leg portions 55a and 55b are in contact with an outer surface of the cover body 4a positioned between the pair of side leg guide pieces 4c, and the movement of the side leg portions 55a and 55b in the X-axis direction is further restricted by the pair of side leg guide pieces 4c. The side cover 4a is made of an insulating member such as plastic or metal similar to the bobbin 10.

As shown in FIG. 10, in the present embodiment, the connection portion inner ends 751 and 761 are arranged side by side in the Y-axis direction, and are arranged closer to the winding axis O by W10 in the X-axis direction than the first outer end portion 36 which is one outer edge of the bobbin constituting the device body in the X-axis direction. The connection portion inner ends 771 and 781 are arranged side by side in the Y-axis direction, and are arranged closer to the winding axis O by W20 in the X-axis direction than the first outer end portion 46 which is the other outer edge of the bobbin constituting the device body in the X-axis direction.

With this configuration, in the present embodiment, the primary first terminal portion 71, the primary second terminal portion 72, the secondary first terminal portion 73, and the secondary second terminal portion 74, which constitute the terminal portion 70, can be closer to the winding axis O than the first outer end portion 36 and 46, and the coil device 1 can be downsized.

Widths of W10 and W20 shown in FIG. 10 are not particularly limited, but are preferably designed so that outer peripheries of the wire connection portions 615, 616, 625, and 626 can be disposed on the inner side along the X-axis direction than the first outer end portions 36 and 46. For example, W10 may be 3 mm to 8 mm, and W20 may be 3 mm to 8 mm.

As shown in FIG. 10, in the present embodiment, a central portion 611a of the first lead portion 611 is disposed closer to the winding axis O by W12 along the X-axis direction than the first outer end portion 36 which is one outer edge of the bobbin 10 constituting the device body in the X-axis direction. In the present embodiment, a central portion 612a of the first lead portion 612 is disposed closer to the winding axis O by W14 along the X-axis direction than the first outer end portion 36. The central portion 621a of the second lead portion 621 is disposed closer to the winding axis O by W22 along the X-axis direction than the first outer end portion 46 which is the other outer edge of the bobbin 10 constituting the device body in the X-axis direction. In the present embodiment, a central portion 622a of the second lead portion 622 is disposed closer to the winding axis O by W24 along the X-axis direction than the first outer end portion 46.

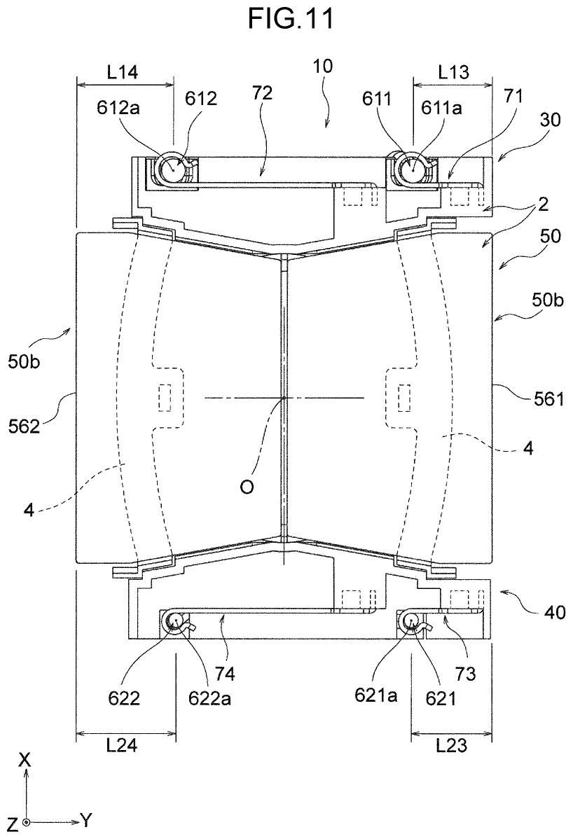

As shown in FIG. 11, in the present embodiment, the central portion 611a of the first lead portion 611 is disposed closer to the winding axis O by L13 along the Y-axis direction than the second outer end portion 561 which is one outer edge of the core 50 constituting the device body in the Y-axis direction. The central portion 621a of the second lead portion 621 is disposed closer to the winding axis O by L23 along the X-axis direction than the second outer end portion 561. In the present embodiment, the central portion 612a of the first lead portion 612 is disposed closer to the winding axis O by L14 along the X-axis direction than the second outer end portion 562 which is the other outer edge of the core 50 constituting the device body in the Y-axis direction. The central portion 622a of the second lead portion 622 is disposed closer to the winding axis O by L24 along the X-axis direction than the second outer end portion 562.

With this configuration, the lead portion can be disposed at four corners as viewed along the winding axis O of the device body 2, which are dead spaces of the coil device. That is, the lead portion can be accommodated inside an outer edge formed by the first outer end portions 36 and 46 of the bobbin 10 and the second outer end portions 561 and 562 of the core 50, which constitute the device body as viewed along the winding axis O, and the coil device can be downsized.

Although widths of W12, W14, W22, and W24 shown in FIG. 10 are not particularly limited, for example, W12 may be 1.5 mm to 4 mm, W14 may be 1.5 mm to 4 mm, W22 may be 1.5 mm to 4 mm, and W24 may be 1.5 mm to 4 mm. Although widths of L13, L23, L14, and L24 shown in FIG. 11 are not particularly limited, for example, L13 may be 5 mm to 20 mm, L23 may be 5 mm to 20 mm, L14 may be 5 mm to 20 mm, and L24 may be 5 mm to 20 mm.

In the specification, the central portion of the lead portion is defined by a contact position between the wire connection portion of the lead portion and the connection portion of the terminal portion. As shown in FIG. 13A, in the wire connection portion 615 of the first lead portion 611, a contact position with the connection portion inner end 751 of the connection portion 75 is a point P1. A point P2 is defined as a position at which a normal line N at the connection portion inner end 751 intersects with an outer periphery of the wire connection portion 615 of the lead portion 611 on the side opposite to the point P1. In the present embodiment, in the wire connection portion 615 of the first lead portion 611, an intermediate position between the point P1 and the point P2 is defined as the central portion 611a. In a portion of the first lead portion 611 other than the wire connection portion 615, a position corresponding to the central portion 611a of the wire connection portion 615 is defined as a central portion 611a according to a shape of an outer periphery of the first lead portion 611. The first lead portion 612 and the second lead portions 621 and 622 are similar to the first lead portion 611.

As shown in FIG. 10, in the present embodiment, in the first coil portion 610 and the second coil portion 620, the central portion 611a of the first lead portion 611 is disposed closer to the winding axis O by W11 along the X-axis direction than first outer peripheral ends 610a1 and 620a1 which are located on one side farthest from the winding axis O in the X-axis direction. The central portion 612a of the first lead portion 612 is disposed closer to the winding axis O by W13 along the X-axis direction than the first outer peripheral ends 610a1 and 620a1. In the first coil portion 610 and the second coil portion 620, the central portion 621a of the second lead portion 621 is disposed closer to the winding axis O by W21 along the X-axis direction than first outer peripheral ends 610a2 and 620a2 located on the other side farthest from the winding axis O in the X-axis direction. The central portion 612a of the first lead portion 612 is disposed closer to the winding axis O along the X-axis direction by W23 than the first outer peripheral ends 610a2 and 620a2. Therefore, the lead portion can be more reliably accommodated inside the first outer end portions 36 and 46.

Widths of W11, W13, W21, and W23 are not particularly limited, but are preferably designed so that outer peripheries of the wire connection portions 615, 616, 625, and 626 can be disposed on the inner side along the X-axis direction than the first outer end portions 36 and 46. For example, W11 may be 1.5 mm to 4 mm, W13 may be 1.5 mm to 4 mm, W21 may be 1.5 mm to 4 mm, and W23 may be 1.5 mm to 4 mm.

As shown in FIG. 10, in the present embodiment, in the first coil portion 610 and the second coil portion 620, the central portion 611a of the first lead portion 611 is disposed closer to the winding axis O by L11 along the X-axis direction than second outer peripheral ends 610b1 and 620b1 which are located on one side farthest from the winding axis O in the Y-axis direction. The central portion 621a of the second lead portion 621 is disposed closer to the winding axis O by L21 along the X-axis direction than the first outer peripheral ends 610b1 and 620b1. In the first coil portion 610 and the second coil portion 620, the central portion 612a of the first lead portion 612 is disposed closer to the winding axis O by L12 along the X-axis direction than second outer peripheral ends 610b2 and 620b2 located on the other side farthest from the winding axis O in the Y-axis direction. The central portion 622a of the second lead portion 622 is disposed closer to the winding axis O along the X-axis direction by L22 than the second outer peripheral ends 610 b2 and 620 b2. Therefore, the lead portion can be more reliably accommodated inside the second outer end portions 561 and 562.

Widths of L11, L12, L21, and L22 are not particularly limited, but are preferably designed so that outer peripheries of the wire connection portions 615, 616, 625, and 626 can be disposed on the inner side along the Y-axis direction than the second outer end portions 561 and 562. For example, L11 may be 0 mm to 10 mm, L12 may be 0 mm to 10 mm, L21 may be 0 mm to 10 mm, and L22 may be 0 mm to 10 mm.

As shown in FIG. 10, in the present embodiment, the connection portions 75, 76, 77, and 78 respectively include terminal extending portions 750, 760, 770, and 780 extending along the first outer end portions 36 and 46. In this way, the connection portion inner ends 751, 761, 771, and 781 can be easily disposed at the four corners, which are dead spaces of the coil device 1, as viewed along the winding axis O of the device body, and a space for connection between the terminal portion and the lead portion can be reduced.

As shown in FIGS. 4A and 4B, in the present embodiment, the terminal portion 70 includes fixing portions 791, 792, 801, 802, 811, 812, 821, and 822 that are fixed to the bobbin. The fixing portions 791, 792, 801, 802, 811, 812, 821, and 822 protrude vertically from the terminal extending portions 750, 760, 770, and 780, respectively, and are inserted into fixing holes 311, 312, 411, 412, 341, 342, 441, and 442 formed in the bobbin shown in FIG. 6A or FIG. 6B. In this way, the coil device 1 can be assembled by attaching the terminal portion to the bobbin after connecting the terminal portion and the lead portion. Therefore, it is not necessary to perform connection work with the terminal portion in a state of being attached to the bobbin in advance by insert molding or the like, and a space for the connection work becomes unnecessary.

As shown in FIGS. 4A and 4B, in the present embodiment, the fixing portions 791, 792, 801, 802, 811, 812, 821, and 822 respectively have retaining portions 791a, 792a, 801a, 802a, 811a, 812a, 821a, and 822a that prevent the fixing portions 791, 792, 801, 802, 811, 812, 821, and 822 from falling off the fixing holes 311, 312, 411, 412, 341, 342, 441, and 442 shown in FIG. 6A or FIG. 6B. Therefore, even when the terminal portion is attached to the terminal block of the bobbin 10 by press-fitting, the terminal portion is less likely to fall off the bobbin 10.

As shown in FIGS. 4A and 4B, in the present embodiment, the connection portions 75, 76, 77, and 78 respectively have engagement portions 750, 760, 770, and 780 on which the lead portions are hooked. Therefore, the lead portion can be temporarily fixed to the connection portion, and the connection work between the lead portion and the connection portion can be easily performed.

As shown in FIG. 7A and FIG. 7B, the primary first terminal portion 71, the primary second terminal portion 72, the secondary first terminal portion 73, and the secondary second terminal portion 74, which constitute the terminal portion 70, respectively have external connection portions 83, 84, 85, and 86 along the winding axis O. As shown in FIG. 12, the external connection portion 83 protrudes from a tip portion 613 of the lead portion by H2. The external connection portions 84, 85, and 86 are similar to the external connection portion 83. Therefore, by a method such as inserting the external connection portions 83, 84, 85, and 86 into a substrate disposed above the coil device 1 in the winding axis direction, time and effort for positioning can be omitted, and the coil device and the substrate can be stably fixed.

In the present embodiment, a height of H2 is not limited, but H2 may be, for example, 5 mm to 10 mm.

As shown in FIG. 12, in the present embodiment, the tip portion 613 of the first lead portion 611 protrudes from a top surface 53b of the upper split core 50b by H1, and H1 is preferably 1 mm or less. Tip portions 614, 615, and 616 are similar to the tip portion 613. The tip portions 613, 614, 615, and 616 may not protrude from the top surface 53b of the upper split core 50b. When the tip portions 613, 614, 615, and 616 do not protrude from the top surface 53b of the upper split core 50b, a height of the coil device 1 in the Z-axis direction can be further reduced.

As shown in FIG. 12, in the present embodiment, the tip portion 613 is covered with the terminal cover 5a. The tip portions 614, 615, and 616 are similar to the tip portion 613. Therefore, the terminal portion can be prevented from falling off the terminal block.

As shown in FIG. 12, in the present embodiment, there is a width W3 between the first outer end portion 36 and one inner wall of the case 100 in the X-axis direction. There is a width W4 between the first outer end portion 46 and the other inner wall of the case 100 in the X-axis direction. Widths of W3 and W4 are not particularly limited, but for example, W3 may be 0.5 mm to 1 mm, and W4 may be 0.5 mm to 1 mm.

In this way, in the present embodiment, a size of the coil device 1 in the X-axis direction can be made smaller than that in the related art.

As shown in FIG. 3, in the present embodiment, the wire 60 includes the first wire 61 including the first coil portion 610 wound around the winding core portion and the first lead portions 611 and 612 led out from the first coil portion 610, and the second wire 62 including the second coil portion 620 wound around the winding core portion and the lead portions 621 and 622 led out from the second coil portion 620. As shown in FIG. 12, the winding partition flange 14 formed on the bobbin 10 is disposed between the first coil portion 610 and the second coil portion 620. Therefore, the coil device 1 can be used as a transformer. In addition, the leakage can be secured via the winding partition flange 14, and the coil device can be suitably used as a leakage transformer. In particular, in the present embodiment, as shown in FIG. 5, the leakage core 3 can be disposed on the winding partition flange 14, and the leakage can be easily adjusted.

As shown in FIG. 9, in the present embodiment, the intermediate guide grooves 191 and 192 through which the first lead portions 611 and 612 pass are formed in the winding partition flange 14. Further, as shown in FIG. 6B, the terminal-side flange portion 24 is formed with end guide grooves 341, 342, 441, and 442 through which the first lead portions 611 and 612 and the second lead portions 621 and 622 pass. Lead-out positions of the first lead portions 611 and 612 and the second lead portions 621 and 622 can be easily determined, and can be easily disposed at predetermined positions inside the outer edge of the device body.

As shown in FIG. 10, in the present embodiment, the first lead portions 611 and 612 and the second lead portions 621 and 622 are electrically connected to the connection portions 75, 76, 77, and 78 by crimping, but the present invention is not limited thereto. For example, the first lead portions 611 and 612 and the second lead portions 621 and 622 may be electrically connected to the connection portions 75, 76, 77, and 78 by soldering. In the present embodiment, even in a case where the connection portion and the lead portion are connected in this manner, the terminal portion can be attached to the terminal block after the connection. Therefore, a space for the connection work becomes unnecessary, and a compact coil device can be easily manufactured.

Various design modifications of the embodiments described above without departing from the scope of the claims are also included in the technical scope.

(Method for Manufacturing Coil Device)

Hereinafter, an example of a method for manufacturing the coil device 1 will be described with reference to FIG. 2 and the like. The coil device 1 according to the present embodiment is manufactured by assembling the members shown in FIG. 2 and winding the first wire 61 and the second wire 62 around the bobbin 10. In manufacturing the coil device 1, first, the bobbin 10 is prepared. The material of the bobbin 10 is not particularly limited, but the bobbin 10 is formed of an insulating material such as resin.

Next, in the bobbin 10, the first wire 61 is wound by a-winding around an outer periphery of the winding core portion 12 between the leg-side flange portion 20 and the winding partition flange 14 to form the first coil portion 610. As shown in FIG. 6A, the first lead portions 611 and 612 of the first wire 61 are led out from the first coil portion 610 toward the outside in the X-axis direction through a space between the leg-side flange portion 20 and the bobbin leg portion 261.

Next, in the bobbin 10, the second wire 62 is wound by a-winding around the outer periphery of the winding core portion 12 between the terminal-side flange portion 24 and the winding partition flange 14 to form the second coil portion 620. As shown in FIG. 6B, the second lead portions 621 and 622 of the second wire 62 are led out from the second coil portion 620 toward the outside in the X-axis direction through the lead-out groove 17.

Next, the wire 60 and the terminal 70 are connected. As shown in FIG. 6A, the wire connection portion 615 of the first lead portion 611 of the first wire 61 constituting the wire 60 is hooked on the engagement portion 750 of the connection portion 75 of the primary first terminal portion 71 constituting the terminal portion 70, and is sandwiched and temporarily fixed between the engagement portion 750 and the terminal extending portion 752. The primary second terminal portion 72 constituting the terminal 70 is connected to the first lead portion 612 of the first wire 61 constituting the wire 60. The wire connection portion 616 of the first lead portion 612 is hooked on the engagement portion 760 of the connection portion 76 of the primary second terminal portion 72, and is sandwiched and temporarily fixed between the engagement portion 760 and the terminal extending portion 762.

As shown in FIG. 6B, the secondary first terminal portion 73 constituting the terminal 70 is connected to the second lead portion 621 of the second wire 62 constituting the wire 60. The wire connection portion 617 of the second lead portion 621 is hooked on the engagement portion 770 of the connection portion 77 of the secondary first terminal portion 73, and is sandwiched and temporarily fixed between the engagement portion 770 and the terminal extending portion 772. The secondary second terminal portion 74 constituting the terminal 70 is connected to the second lead portion 622 of the second wire 62 constituting the wire 60. The wire connection portion 626 of the second lead portion 622 is hooked on the engagement portion 780 of the connection portion 78 of the secondary second terminal portion 74, and is sandwiched and temporarily fixed between the engagement portion 780 and the terminal extending portion 782.

In a state in which the wire connection portion of each lead portion and the connection portion of each terminal portion shown in FIGS. 6A and 6B are temporarily fixed, the wire connection portion and the connection portion are electrically connected by thermocompression bonding. The connection between the wire connection portion and the connection portion may be performed by a known method such as connection by soldering as appropriate, but as an example, the thermocompression bonding between the wire connection portion 615 and the connection portion 75 will be described with reference to FIGS. 13A and 13B.

FIG. 13A shows a state in which the wire connection portion 615 and the connection portion 75 are temporarily fixed. In the state, a current flows from a main electrode 200 to a sub-electrode 300. In the present embodiment, the wire 60 is insulated by the insulating film 60b formed around the core member 60a. When a current flows between the main electrode 200 and the sub-electrode 300 in the state of FIG. 13A, the current does not flow to the wire 60 but flows to the connection portion 75.

FIG. 13B shows a state in which the wire connection portion 615 and the connection portion 75 are electrically connected. From the state of FIG. 13A, the main electrode 200 is pressed toward the terminal extending portion 752 while a current flows from the main electrode 200 to the sub-electrode 300, and a pressure is applied to the engagement portion 750 to crush the wire connection portion 615. In this way, the insulating film 60b is peeled off, the core member 60a and the connection portion 74 are in contact with each other, and the current also flows through the wire connection portion 615. When the current flows through the wire connection portion 615, the insulating film 60b is further peeled off due to resistance heat generation. Due to the resistance heat generation and the pressure applied by the main electrode 200, the core member 60a in the wire connection portion 615 and the connection portion are electrically connected to each other, and the state shown in FIG. 13B is obtained. Similarly, the wire connection portions 616, 617, and 618 are electrically connected to the connection portions 76, 77, and 78.

Next, the terminal portion 70 is attached to the terminal blocks 30 and 40. As shown in FIG. 6A, the insulating cover 6a is attached to the intermediate guide groove 191 and the end guide groove 341. The first lead portion 611 is led out to the outside of the guide protrusion 221 in the Y-axis direction. As shown in FIG. 7A, the first lead portion 611 is led out upward in the Z-axis direction and passed through the groove of the insulating cover 6a. The fixing portion 791 abuts on the fixing hole 311, the fixing portion 792 abuts on the fixing hole 312, and the primary first terminal portion 71 is pressed inward in the X-axis direction. In this way, the fixing portion 791 is press-fitted into the fixing hole 311, the fixing portion 792 is press-fitted into the fixing hole 312, and the primary first terminal portion 71 is attached to the first terminal installation portion 310.

As shown in FIG. 6A, the insulating cover 6b is attached to the intermediate guide groove 192 and the end guide groove 342. The first lead portion 612 is led out to the outside of the guide protrusion 222 in the Y-axis direction. As shown in FIG. 7A, the first lead portion 612 is led out upward in the Z-axis direction and passed through the groove of the insulating cover 6b. The fixing portion 801 abuts on the fixing hole 321, the fixing portion 802 abuts on the fixing hole 322, and the primary second terminal portion 72 is pressed inward in the X-axis direction. In this way, the fixing portion 801 is press-fitted into the fixing hole 321, the fixing portion 802 is press-fitted into the fixing hole 322, and the primary second terminal portion 72 is attached to the second terminal installation portion 320.

As shown in FIG. 6B, the second lead portion 621 is led out to the outside of the guide protrusion 161 in the Y-axis direction. As shown in FIG. 7B, the second lead portion 621 is led out upward in the Z-axis direction and passed through the end guide groove 441. The fixing portion 811 abuts on the fixing hole 411, the fixing portion 812 abuts on the fixing hole 412, and the secondary first terminal portion 73 is pressed inward in the X-axis direction. In this way, the fixing portion 811 is press-fitted into the fixing hole 411, the fixing portion 812 is press-fitted into the fixing hole 412, and the secondary first terminal portion 73 is attached to the first terminal installation portion 410.

As shown in FIG. 6B, the second lead portion 622 is led out to the outside of the guide protrusion 162 in the Y-axis direction. As shown in FIG. 7B, the second lead portion 622 is led out upward in the Z-axis direction and passed through the end guide groove 442. The fixing portion 821 abuts on the fixing hole 421, the fixing portion 822 abuts on the fixing hole 422, and the secondary second terminal portion 74 is pressed inward in the X-axis direction. In this way, the fixing portion 821 is press-fitted into the fixing hole 421, the fixing portion 822 is press-fitted into the fixing hole 422, and the secondary second terminal portion 74 is attached to the second terminal installation portion 420.

Thereafter, the terminal cover 5a is attached to the terminal block 30, and the terminal cover 5b is attached to the terminal block 40. The terminal covers 5a and 5b may be fixed to the terminal blocks 30 and 40 using an adhesive. In order to attach the terminal portion 70 to the terminal blocks 30 and 40, an adhesive may be used instead of press-fitting of the fixing portion or in addition to press-fitting of the fixing portion.

Next, the leakage core 3 is disposed in the lateral grooves 181 and 182 of the bobbin 10, the side cover 4 is attached to both sides of the bobbin 10 in the Y-axis direction, and then the core 50 is attached from above and below in the Z-axis direction. That is, the lower split core 50a is attached to the bobbin 10 from below in the Z-axis direction, and the upper split core 50b is attached to the bobbin 10 from above in the Z-axis direction. The distal ends of the side leg portions 55a and 55b are joined to each other while providing a gap between the distal ends of the middle leg portions 54a and 54b of the lower split core 50a and the upper split core 50b as necessary. Examples of the material of the lower split cores 50a and the upper split cores 50b include, but are not limited to, soft magnetic materials such as metal and ferrite.

Next, an assembly including the bobbin 10, the wire 60, the core 50, and the like described above is accommodated in the case 100 whose upper portion is open, and a potting resin for heat dissipation is filled inside the case 100 to obtain the coil device 1 according to the present embodiment.

### EXPLANATIONS OF LETTERS OR NUMERALS

1 coil device
2 device body
10 bobbin
12 winding core portion
13 core leg through hole
14 winding partition flange
15 lead-out notch
161, 162 guide protrusion
17 lead-out groove
181, 182 lateral groove
191, 192 intermediate guide groove
20 leg-side flange portion
21 lead-out notch
221, 222 guide protrusion
24 terminal-side flange portion
261, 262 bobbin leg portion
30, 40 terminal block
30a, 40a first end side
30b, 40b second end side
310, 410 first terminal installation portion
311, 312, 411, 412 fixing hole
320, 420 second terminal installation portion
321, 322, 421, 422 fixing hole
341, 342, 441, 442 end guide groove
36, 46 first outer end portion
50 core
50a lower split core
50b upper split core
52a, 52b base portion
53a, 53b top surface
54a, 54b middle leg portion
55a, 55b side leg portion
561, 562 second outer end portion
60 wire
60a core member
60b insulating film
61 first wire
610 first coil portion
610a1, 610a2 first outer peripheral end
610b1, 610b2 second outer peripheral end
611, 612 first lead portion
611a, 612a central portion
613, 614 tip portion
615, 616 wire connection portion
617, 618 base end portion
62 second wire
620 second coil portion
620a1, 620a2 first outer peripheral end
620b1, 620b2 second outer peripheral end
621, 622 second lead portion
621a, 622a central portion
623, 624 tip portion
625, 626 wire connection portion
627, 628 base end portion
70 terminal portion
71 primary first terminal portion
72 primary second terminal portion
75, 76 connection portion
750, 760 engagement portion
751, 761 connection portion inner end
752, 762 terminal extending portion
791, 792, 801, 802 fixing portion
791a, 792a, 801a, 802a retaining portion
83, 84 external connection portion
73 secondary first terminal portion
74 secondary second terminal portion
77, 78 connection portion
770, 780 engagement portion
771, 781 connection portion inner end
772, 782 terminal extending portion
811, 812, 821, 822 fixing portion
811a, 812a, 821a, 822a retaining portion
85, 86 external connection portion
3 leakage core
4 side cover
4a cover body
4b engagement piece
4c side leg guide piece
5a, 5b terminal cover
5a0, 5b0 terminal protection piece
5a1, 5a2, 5b1, 5b2 external connection notch
5a3, 5b3 side protection piece
6a, 6b insulating cover
100 case
200 main electrode
300 sub-electrode

What is claimed is:

1. A coil device comprising:
a bobbin having a winding core portion with a hollow cylindrical shape;
a core at least partially disposed inside the winding core portion;
a wire having a coil portion wound around the winding core portion and a lead portion having a wire connection portion led out from the coil portion to extend substantially parallel to a winding axis of the coil portion; and
a terminal portion having a connection portion connected to the wire at the wire connection portion, wherein
a connection portion inner end of a contact portion of the wire connection portion in the connection portion is located at a position closest to the winding axis in a first axis direction perpendicular to the winding axis, and the connection position inner end is disposed closer to the winding axis in the first axis direction than a first outer end portion located at a position farthest from the winding axis in the first axis direction in the bobbin.

2. The coil device according to claim 1, wherein
the first axis direction is a bobbin longitudinal direction perpendicular to a bobbin lateral direction in which a length of the bobbin is shortest among directions perpendicular to the winding axis, and
the first outer end portion extends along the bobbin lateral direction.

3. The coil device according to claim 2, wherein
the connection portion includes a terminal extending portion extending along the first outer end portion.

4. The coil device according to claim 3, wherein
the terminal portion includes a fixing portion fixed to the bobbin, and
the fixing portion protrudes perpendicularly from the terminal extending portion and is inserted into a fixing hole formed in the bobbin.

5. The coil device according to claim 4, wherein
the fixing portion includes a retaining portion that prevents the fixing portion from falling off the fixing hole.

6. The coil device according to claim 1, wherein
the connection portion includes an engagement portion on which the lead portion is hooked.

7. The coil device according to claim 1, wherein
the terminal portion includes an external connection portion protruding from a tip portion of the lead portion along the winding axis.

8. The coil device according to claim 1, wherein
the wire includes
a first wire having a first coil portion wound around the winding core portion and a first lead portion led out from the first coil portion, and
a second wire having a second coil portion wound around the winding core portion and a lead portion led out from the second coil portion, and
a winding partition flange formed on the bobbin is disposed between the first coil portion and the second coil portion.

9. The coil device according to claim 1, wherein
the lead portion is electrically connected to the connection portion by crimping or soldering.

10. A coil device comprising:
a bobbin having a winding core portion with a hollow cylindrical shape;
a core at least partially disposed inside the winding core portion;
a wire having a coil portion wound around the winding core portion and a lead portion having a wire connection portion led out from the coil portion to extend substantially parallel to a winding axis of the coil portion; and
a terminal portion having a connection portion connected to the wire at the wire connection portion, wherein
a central portion of the lead portion
is disposed at an outer edge of a device body including the bobbin and the core and closer to the winding axis along a first axis than a first outer end portion located at a position farthest from the winding axis in a first axis direction perpendicular to the winding axis, and
is disposed at the outer edge of the device body and closer to the winding axis along a second axis than a second outer end portion located at a position farthest from the winding axis in a second axis direction perpendicular to the winding axis and the first axis.

11. The coil device according to claim 10, wherein
the first outer end portion is disposed on the bobbin, and
the second outer end portion is disposed on the core.

12. The coil device according to claim 11, wherein
the bobbin is formed with a terminal-side flange portion on which a terminal block to which the terminal portion is attached is disposed, and
the terminal-side flange portion is formed with an end guide groove through which the lead portion passes.

13. The coil device according to claim 10, wherein
the central portion
is disposed closer to the winding axis along the first axis than a first outer peripheral end located at a position farthest from the winding axis in the first axis direction in the coil portion, and
is disposed closer to the winding axis along the second axis than a second outer peripheral end located at a position farthest from the winding axis in the second axis direction in the coil portion.

14. The coil device according to claim 10, wherein
the wire includes
a first wire having a first coil portion wound around the winding core portion and a first lead portion led out from the first coil portion, and
a second wire having a second coil portion wound around the winding core portion and a lead portion led out from the second coil portion, and
a winding partition flange formed on the bobbin is disposed between the first coil portion and the second coil portion.

15. The coil device according to claim 14, wherein
the winding partition flange is formed with an intermediate guide groove through which the lead portion passes.

16. The coil device according to claim 10, wherein
the terminal portion includes an external connection portion protruding more than a tip portion of the lead portion along the winding axis.

17. The coil device according to claim 16, wherein
the tip portion is covered with a terminal cover.

18. The coil device according to claim 10, wherein
the lead portion is electrically connected to the connection portion by crimping or soldering.
